(19) United States
(12) Patent Application Publication
(10) Pub. No.: US 2026/0253068 A1
(43) Pub. Date: Aug. 27, 2026

(54) MIXERS AND REGULATED MIXERS

(71) Applicant: Silvio Micali, Brookline, MA (US)

(72) Inventor: Silvio Micali, Brookline, MA (US)

(21) Appl. No.: 19/089,086

(22) Filed: Mar. 25, 2025

Related U.S. Application Data
(60) Provisional application No. 63/763,327, filed on Feb. 26, 2025.

(51) Int. Cl. G06Q 20/38; G06Q 20/40

(52) U.S. Cl. CPC G06Q 20/3829; G06Q 20/38215; G06Q 20/4014

(57) ABSTRACT

Transferring a quantity of tokens to a withdrawing party includes receiving a deposit request from a depositing party, creating a withdrawal authorization that does not identify the depositing party, and receiving a withdrawal request that requests transfer of the quantity of tokens to the withdrawing party. A digital certificate has a signature of a trusted authority that verifies an identity of the withdrawing party. The digital certificate is verified, the indication that at least the quantity of tokens is available for withdrawal by the withdrawing party is verified, and the quantity of tokens is issued in response to confirming validity of the digital certificate and confirming the indication that at least the quantity of tokens is available for withdrawal by the withdrawing party. The withdrawing party may provide the digital certificate and/or the indication that at least the quantity of tokens is available for withdrawal by the withdrawing party.

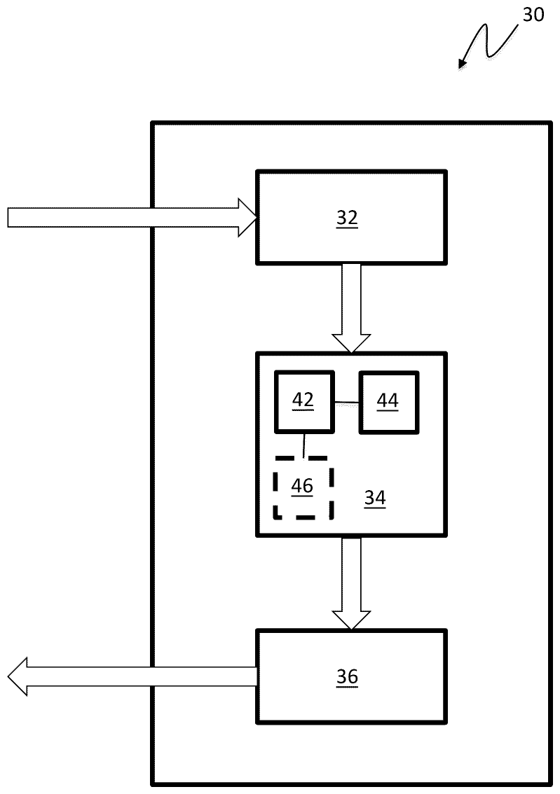

### TECHNICAL FIELD

This application relates to the field of cryptography and more particularly to the field of using cryptography to transfer tokens between parties in an anonymous but traceable fashion.

### BACKGROUND OF THE INVENTION

Cryptographic hashing, digital signatures, digital certificates, public-key encryption, blockchains, smart contracts, and tokens are often used for cryptographic digital transaction systems.

Cryptographic Hashing. A cryptographic hash function (hash function for short) is an easy-to-compute function H for which it is hard to find a collision, that is, two different inputs x and y such that H(x)=H(y). Furthermore, whenever x is not clear from context, it is computationally hard to retrieve x from H(x).

Digital Signatures. In a digital system, many transactions are executed by public keys via digital signatures. A digital signature of a message (string) m, relative to a public key PK, is a string proving to anyone that m has been authenticated relative to PK. Such a signature of m is denoted by SIG_{PK}(m). Because only the owner of PK—i.e., the entity or the person knowing PK's secret key—can compute SIG_{PK}(m) on input m, in a context in which PK's owner, O, is clear, we may identify key PK with O and write SIG_{O}(m) instead of SIG_{PK}(m). In some contexts, the message m and/or the public key PK may be directly computable from SIG_{PK}(m). In others, m and PK may not be computable from SIG_{PK}(m). For example, it is possible to hash m prior to signing m. That is, SIG_{PK}(H(m)) is equated to SIG_{PK}(m), where H is a hash function. For simplicity, SIG_{PK}(m) is shorthand for (m, PK, SIG_{PK}(m)), which makes it immediately clear both the signed message m and the public key PK.

Digital Certificates. A digital certificate may be used to prove that a given public key PK is authorized by an authority A, owning a public key PK_{A}.

Typically, A issues a certificate for PK after a proper Know Your Customer (KYC) process, conducted by A or another proper entity, so that the certificate vouches that the identity of PK's owner is properly known. This identity information may be explicitly included in the certificate or the identity information may be kept separately (e.g., in a private database), and provided on a need-to-know basis (e.g., in response to a court order).

The certificate may certify PK together with some additional information ai: for instance, time information, duration of the digital certificate, a set of tasks that are authorized for PK by the certificate, or the empty information (no information). In such a case, the certificate may consist of the signature SIG_{PK}_{_{A}}(PK, ai). When it is not crucial to make such additional information explicit, it is possible to only write SIG_{A}(PK). Such a certificate may be used in any application that knows (trusts) A's public key. Since the application can verify SIG_{PK}_{_{A}}(PK, ai), the application can also learn PK and that PK has been properly authorized, and thus can verify signatures corresponding to PK too.

Sometimes, the verifier of a certificate SIG_{PK}_{_{A}}(PK) may not know the public key PK_{A} of authority A but may know the public key, PK_{B}, of another, possibly higher, authority B that has issued a certificate for PK_{A}, SIG_{B}(PK_{A}). In this case, a certificate for PK may also include (or be accompanied by) SIG_{B}(PK_{A}). Together, SIG_{B}(PK_{A}) and SIG_{A}(PK) may be taken to be a single, compound certificate for PK. This compound certificate can be considered issued by B, A, or both.

Generating compound certificates may be generalized. For instance,
authority A₁ may issue a certificate SIG_{A}_{₁}(PK_{A}_{₂}),
authority A₂ may issue a certificate SIG_{A}_{₂}(PK_{A}_{₃}),
. . .
Authority Aₖ may issue a certificate SIG_{A}_{ₖ}(PK) for PK.

Each certificate for PK_{A}_{ᵢ} may of course specify some additional information. For instance, information vouching Aᵢ's ability to issue certificates of a given type. The sequence SIG_{A}_{₁}(PK_{A}_{₂}), SIG_{A}_{₂}(PK_{A}_{₂}), . . . , SIG_{A}_{ₖ}(PK) is a compound certificate for PK issued by authority A₁, or any other authority Aᵢ in the chain. For short, and to stress the issuing authority Aᵢ, it is possible to write SIG_{A}_{ᵢ}(PK) to indicate such a compound certificate. In particular, SIG_{A}_{ᵢ}(PK) may stand for:

$${SIG}_{{A}_{1}} ( {PK}_{{A}_{2}} ) , {SIG}_{{A}_{2}} ( {PK}_{{A}_{3}} ) , … , {SIG}_{{A}_{k}} ( PK ) ; \\ {SIG}_{{A}_{i}} ( {PK}_{{A}_{i + 1}} ) , {SIG}_{{A}_{i + 1}} ( {PK}_{{A}_{i + 2}} ) , … , {SIG}_{{A}_{k}} ( PK ) ; or$$

$${SIG}_{{A}_{j}} ( {PK}_{{A}_{j + 1}} ) , … , {SIG}_{{A}_{i}} ( {PK}_{{A}_{i + 1}} ) , … , {G}_{{A}_{k}} ( PK ) .$$

Compound certificates make it possible for A₁ to certify the public keys of one or more authorities A₂, each of which may certify the public keys of one or more authorities A₃, and so on, until some authority Aₖ issues an ordinary certificate for a public key PK. Accordingly, an authority can verify a compound certificate for PK even if the authority knows in advance only the public key of A₁ or of any authority Aᵢ in the chain. Note that the term “certificate” includes an ordinary certificate or a compound certificate.

Public-Key Encryption. Encryption (whether public-key based or not) enables a message to be transmitted so that only intended recipient(s) of the message can understand the message. An encryption of a message m may be denoted by E(m). In a public-key encryption scheme, one generates a pair of matching keys, PK and SK, publishes PK and keeps secret SK. Given a message m, anyone can use PK to compute its encryption, E_{PK}(m). Such encryption (1) hides m from anyone who does not know SK, but (2) makes m easily computable with knowledge of SK.

In some contexts (e.g., in some encryption schemes), the public key PK may be directly computable from E_{PK}(m). In others, the public key PK is not. For simplicity, E_{PK}(m) is shorthand for (PK, E_{PK}(m)), which makes the public key immediately clear from the ciphertext.

An encryption of a message m could be deterministic or probabilistic. In the latter case, m is encrypted using a random string r, that is, E(m)=E(m, r). (In a sense, the “overall message” is (m, r), while the “intended” message is m, and r is just an “auxiliary message” that can be easily separated—e.g., a random string of a given length.) A special property of such a probabilistic encryption of m is that, even one who know m, or thinks that m is a possible candidate for the (intended) message, cannot verify that this is the case.

Blockchains. In a blockchain, transactions are organized in a sequence of blocks. New blocks are added to the chain by a consensus process run by a set of validators. Everyone in the system can post their transactions on the chain and read all transactions posted in the same sequence of blocks—but no one is able to alter the order of the blocks or the transactions within each block.

Blockchains can be permissionless or permissioned. In a permissionless chain, a new public key typically joins the system as soon as a suitable transaction involving the new public key (e.g., a payment to an entity possessing the new public key) is posted by an entity possessing another key already in the system; and any entity is allowed to become a validator, if the entity complies with some simple steps. In a permissioned chain, new keys must be approved to join the system.

Smart Contracts. A smart contract SC is, de facto, a public piece of code, posted on the blockchain, capable of (a) storing information, (b) owning assets and tokens, (c) receiving inputs and generating outputs, and (d) automatically execute transactions, if some proper conditions are satisfied. In the description herein, it is possible to personalize a smart contract as a shorthand way to represent smart contract operations, for instance, by using expressions such as “sending a message (or an input) to SC” or “SC posts (or executes) a transfer (or a transaction).”

Tokens. Blockchain tokens are extremely versatile. Blockchain tokens can represent cryptocurrencies, stablecoins, NFTs, tokens arising from the tokenization of assets (e.g., bonds, industrial plants, mineral deposits, oil fields), etc. Tokens are fungible if the tokens are interchangeable with one another, such as stablecoins or units of a cryptocurrency.

For simplicity, but without any loss of generality intended, the discussion below focuses on a single class of fungible tokens. This facilitates the discussion herein so that, for each public key, it is possible to use a single number to specify the number of tokens corresponding to the public key, rather than, for each class of an innumerable class of tokens, A, B, C, . . . , the number of tokens t_{A} of class A, the number of tokens t_{B} of class B, etc., corresponding to a given key.

A Lingering Privacy Need. Blockchains have an enormous potential to make more efficient and secure the way to transact. Smart contracts can effectively handle tasks that previously required costly intermediaries. In particular, asset tokenization can dramatically increase the liquidity and security of financial markets. Whether tokenized assets represent money, assets, or pieces of assets, tokens are easily exchanged among owners of public keys in a transparent and secure manner. Indeed,
Each token transfer occurs from an owner of a first public key, PK₁, to an owner of a second public key, PK₂, and
Each such transfer is posted, publicly, inalterably, and finally on the chain.

As a result, at each point in time, the blockchain provides an accurate and secure record of which public key is associated with which tokens and how many. If a first entity associated with PK₁ promises to transfer T tokens (of a given class) to a second entity associated with PK₂, then the second entity can indeed verify that the first entity owns a number of tokens sufficient to make the transfer. And once the transfer is posted, the second entity and the entire world knows that the second entity is now the owner of the tokens transferred, or that the second entity posses T additional tokens, if the second entity had already some tokens.

Such transparency is a tremendous boost to economic activity. At the same time, however, it negatively affects the legitimate privacy needs that are also necessary to economic activity.

To be sure, a public key PK may not, per se, disclose the identity of an owner of the public key. Indeed, key PK is privately generated by its owner, together with a matching secret key SK that allows the owner to produce digital signatures relative to PK. To enable anyone to verify such digital signatures, the owner makes PK public (hence the term ‘public key’)—without divulging that PK belongs to the owner!—and keeps SK secret (hence the term ‘secret key’) in order to be the only one to able to sign messages relative to PK. Accordingly, one who sees a freshly generated public key PK may not have any idea to whom it belongs. All such an observer sees is a “randomly looking” datastring. However, after PK starts to transact—e.g., to buy certain tokens and selling certain other tokens—the nature and number of these transactions may reveal the identity of the owner of PK. This situation is similar to what happens with a credit card. A credit card number does not, per se, reveal the identity of the card's owner. But this identity could be reconstructed, or guessed with reasonable accuracy, by someone with sufficient machine-learning capabilities, from the history of purchases made by the card. In fact, the situation is somewhat worse. In a credit card context, an ordinary person is not able to monitor all credit-card transactions. In a blockchain, all transactions are public and inalterably posted.

The following approaches have been considered to remedy blockchains' lack of privacy: (1) private chains, (2) encryption and zero-knowledge, (3) mediated systems, (4) “self-transactions”, and (5) mixers. Unfortunately, these approaches do not offer perfect solutions.

Private Chains. Private blockchains prevent outsiders from accessing the chain's transactional history and thus from figuring out which insider owns which key. However, private blockchains are transparent to insiders and therefore cannot prevent a resourceful insider from figuring who owns which key based on the posted transactional history.

Encryption and Zero-Knowledge. Zero Knowledge proofs are a well-known technique to prove that something is true without revealing any other detail or explanation. Focus for a moment on a single type of tokens. Rather than transparently showing the number of tokens, n, held by a given public key PK, the blockchain may associate to PK only the encrypted value, E(n), of n, or a commitment to n, for instance H(m), indeed, an encryption can be viewed as a form of a commitment. Using encryption for concreteness, but without any limitation intended, assume that an owner of a key PK₁, owning n₁ tokens, wants to transfer 100 tokens to an other entity that owns a key PK₂ owning n₂ tokens. In this case, the ciphertext E(n₁) is associated to PK₁, and the ciphertext E(n₂) is associated to PK₂. To make the desired transfer, the owner of PK₁ may digitally sign and post (a) the encryption E(100), (b) a zero-knowledge proof that the owner of PK₁ has a number of tokens greater than those currently transacted (i.e., that n₁>100, without revealing either number), and (c) information enabling the blockchain to properly keep track of the updated encrypted numbers of tokens owned by the owner of PK₁ and the other entity that owns PK₂ caused by the transfer. As a result, E(n₁−100) is the new encrypted value associated to PK₁, and E(n₂+100) the new encrypted value associated to PK₂. Note that zero knowledge has many variants and generalization that include multi-party computation (MPC), where multiple parties possessing a public key could engage in a joint computation over encrypted data so that everyone is guaranteed that the result of the computation is correct without revealing the individual inputs and outputs. Unfortunately, these tools do not generate vibrant marketplaces.

Problem. This and other zero-knowledge approaches suffer from at least two main problems. First, they do not hide the fact that PK₁ is transacting with PK₂. Second, they do not provide a vibrant marketplace. In a vibrant marketplace one readily sees who owns which tokens. In a setting where owners of keys secretly own their assets, transacting is harder, less efficient, and less intuitive.

Mediated Systems. One may set up a centralized and private system within a public blockchain, where a “manager” (or a group of managers), and preferably only such a manager, knows who owns what. When an entity wants to buy some number of tokens of a given type, the entity makes a request to the manager who acts as an intermediary. For instance, the manager contacts someone who owns the desired tokens; brokers a transaction without divulging the identities of the seller or the buyer; and updates the record of the manager that indicates who owns what in the system after the transaction. Society has relied on mediated systems from time immemorial to guarantee transaction privacy and correctness. Such systems, however, typically require a substantial amount of trust. In particular, one must trust the intermediary to keep secret a transaction's details. Unfortunately, a dishonest mediator may divulge the transaction details. Worse, it is very hard to prove that an intermediary has secretly transferred such details to another party, if both parties wish to hide the transfer of such details.

Self-Transactions. A very popular way for the owner of a key PK₁ to hide that the key transfers tokens to another entity that owns a key PK₂ is to artificially create new public/secret key pairs,

$$( P {K}_{1}^{′} , S {K}_{1}^{′} ) , … , ( P {K}_{j}^{′} , S {K}_{j}^{′} ) ;$$

transfer some numbers of tokens PK₁ to the new public/secret key pairs; and then transfer tokens to the other entity that owns PK₂ using the new public/secret key pairs. This approach may confuse a simple observer, but not a sophisticated one.

Mixers. A mixer is a blockchain system that uses a public key D to transfer fungible tokens to an owner of another public key W. Typically, these transfers are executed via deposits and withdrawals, preferably with the sole help of a smart contract SC.

In a deposit, the owner of D (1) transfers a first number of tokens to SC, and (2) makes available to SC some withdrawing information authorizing a withdrawal of a second number of tokens only once to another entity.

In a withdrawal, the owner of W proves to SC that the owner of W is authorized to withdraw a second number of tokens by the withdrawing information of one of the deposits made so far, without revealing which deposit. The owner of W also proves that no one has already withdrawn tokens relative to that deposit, whichever it may be.

Contract SC verifies the proof from the owner of W and, if the proof is correct, then SC transfers the second number of tokens to the owner of W and possibly stores information preventing anyone from withdrawing tokens relative to the same deposit.

TORNADO CASH. An example of a mixer is Tornado Cash in which a first number of tokens (deposit) and a second number of tokens (withdrawal) are the same and fees are paid separately.

The [symbol] th depositor, an owner of a public key D, transfers a number of tokens T to the smart contract SC and posts H(k, r), the cryptographic hash two randomly and secretly selected strings. (the owner of D will privately communicate the three strings [symbol] , k, and r to a withdrawer, an owner of a public key W, of his choice to enable the owner of W to withdraw, T tokens at most once).

In a subsequent withdrawal, the owner of W essentially proves in zero knowledge to SC that the owner of W knows:
the first string k associated to the [symbol] th deposit (without revealing k and [symbol] ), and
the second string r associated to the [symbol] th deposit (without revealing r and [symbol] ).

Further, the owner of W posts a “nullifier hash” H₁(k), where H₁ is a cryptographic hash function (possibly equal to H), and proves, again in zero knowledge, that H₁(k) is indeed the hash of the first string.

The smart contract SC of Tornado Cash keeps a list, L, of all nullifier hashes used so far and checks that H₁(k) is not in L, to prevent “double withdrawal.” If proofs of the owner of W are correct, and H₁(k) is not in Lt, then SC adds H₁(k) to L and transfers T tokens to the owner of W. In this regard, Tornado Cash uses a clever and secure data structure, a Merkle tree, to store the secret withdrawal information of the [symbol] th deposit. This enables Tornado Cash to have more efficient proofs. Namely proofs that are logarithmic, rather than linear, in the number of deposits.

Note: In a sense, by proving knowledge of string r the owner of W proves entitlement to withdraw T tokens, and, by proving knowledge of k and by posting of H₁(k), the owner of W proves that no one, including himself, has already withdrawn T tokens relative to the same [symbol] , k, and r.

MIXER PRIVACY. Notice that a mixer may provide much desirable privacy by breaking the traceable transactional history of a public key. For example, assume that all users deposit T tokens and that W is the first public key used to withdraw T tokens after 100 deposits are publicly posted, say, by depositors with public keys D₁, . . . , D₁₀₀. Then, everyone sees that each owner of Dᵢ has transferred T tokens to the mixer and that the owner of W has withdrawn T tokens. However, no one, even the most sophisticated observer, can tell which of the 100 depositors is linked to the owner of W.

Moreover, the privacy provided by a mixer M does allow a vibrant marketplace. Indeed, while the identities of the owners of the public keys using M may be “privatized”, it is always transparent which public keys own which tokens.

MIXER PROBLEMS. Unfortunately, mixer privacy can be used (and has been used) for money laundering or other illegal activities, such as financing terrorism. This is why Tornado Cash has been blacklisted by the US Department of Treasury, making it illegal for U.S. citizens, residents, or companies to receive or send money via Tornado Cash.

Also unfortunately, however, such blocklisting leaves law-abiding blockchain users to rely only on less effective forms of privacy, such as self-transactions. De facto, the current situation is that law-abiding users are deprived of the strong privacy offered by mixers, while criminals or users disregarding the law can enjoy it.

### SUMMARY OF THE INVENTION

The system described herein addresses the issues set forth above by providing a new class of mixers, regulated mixers, which include certificate-based mixers, authority-traceable mixers, and combined regulated mixers.

CERTIFICATE-BASED MIXERS. Regulated mixers of this type address the privacy needs of certified public keys. Owners of such keys may have obtained a corresponding certificate to be able to transact in, say, a given class of securities. The identity of the owners of certified keys is already known to a proper authority, for instance the same authority which issues the certificate. Thus, such keys do not present a problem for law-enforcement, because such an authority could collaborate in the case of, say, the investigation of a money-laundering incident. However, the owners of the certificates and corresponding keys (e.g., security traders) are in need of privacy from their competitors as well as from the rest of the world. The owners can thus obtain privacy from a certificate-based regulated mixer. For instance, after a couple of trades, an owner of a particular certified key may want to use a regulated mixer to break a transactional history of the key in the eyes of the rest of the world.

Notice that the needs of law-enforcement can be successfully addressed even by a certificate-based mixer that requires only that withdrawers use certified keys. In fact, it is not even necessary to trace a certifier withdrawer that owns a key W to a corresponding depositor that owns a key D. After all, such a withdrawer cannot engage in illegal activities with impunity, because the certificate of the withdrawer vouches that a proper authority knows the identity of the withdrawer.

Yet, it is also possible to construct certificate-based mixers that also require that depositors to be owners of certified keys, and, as set forth in detail elsewhere herein, guarantee that each certified withdrawer is correctly linkable to a depositor, certified or not, by a proper authority.

AUTHORITY-TRACEABLE MIXERS. A regulated mixer of this type may not require that withdrawers, or depositors, or both are properly certified, but ensure that a proper authority, A, is made able to learn which withdrawer, and owner of a public key W, is linked to which depositor, an owner of a public key D.

In one embodiment, A learns that W correspond to D because, when the owner of D makes a deposit, the owner of D also specifies a probabilistic encryption, EPKA (W), of an account of the owner of W relative to a public encryption key PK_{A} whose secret key is known by A. To withdraw tokens, the owner of W must also prove (preferably, in a zero knowledge way) that W is indeed the decryption of E (W). Mixers of the second type are made authority-traceable by the withdrawers.

In other embodiments, A learns that W corresponds to D via some encrypted information posted by the owner of W during a withdrawal. In others yet, via encrypted information posted by both the owner of D and the owner of W.

COMBINED REGULATED MIXERS. Such mixers are both certificate-based and authority traceable.

According to the system described herein, transferring a quantity of tokens from a depositing key of a depositing party to a withdrawing key of a withdrawing party includes receiving a deposit of at least the quantity of tokens for withdrawal by the withdrawing key and a withdrawal authorization for the quantity of tokens that does not identify the depositing key or the withdrawing key, receiving a proof that the withdrawing key is authorized to receive the quantity of tokens, the proof not revealing the depositing key or the withdrawing key, receiving a first digital certificate having a signature at least one authority that certifies that an identity of the withdrawing party can be caused to be revealed, verifying the validity of the first digital certificate based on the signature of the at least one authority, verifying that the withdrawing key is authorized to withdraw the quantity of tokens, and causing a transfer of the quantity of tokens to the withdrawing key in response to confirming validity of the first digital certificate and confirming that the withdrawing key is authorized to receive the quantity of tokens. The withdrawing party may provide the first digital certificate and/or the proof. The at least one authority may correspond to a plurality of authorities, each having a portion of a secret key used to issue/digitally sign the first digital certificate, or may be a single authority. The at least one authority may reveal the identity of the withdrawing party in response to an appropriate request therefor. Transferring a quantity of tokens from a depositing key of a depositing party to a withdrawing key of a withdrawing party may also include receiving a second digital certificate that certifies that an identity of the depositing party can caused to be revealed. The second digital certificate may be issued by a same authority that issues the first digital certificate. The at least one authority may reveal the identity of the depositing party in response to an appropriate request therefor.

According further to the system described herein, transferring a quantity of tokens from a depositing key of a depositing party to a withdrawing key of a withdrawing party includes receiving at a given time a deposit of at least the quantity of tokens for withdrawal by the withdrawing key, receiving identifying information that identifies the withdrawing key, the identifying information being encrypted using a public key of a first authority to provide an encrypted value that is securely coupled to at least one of: the depositing key or the deposit or the depositing party, receiving a proof that a decryption of the encrypted value identifies the withdrawing key, the proof not revealing the depositing key or the deposit to which the encrypted value is securely coupled, verifying the proof, and causing a transfer of the quantity of tokens to the withdrawing key in response to confirming validity of the proof. The withdrawing key may be unknown at the given time of deposit. The proof may be a zero-knowledge proof. Transferring a quantity of tokens from a depositing key of a depositing party to a withdrawing key of a withdrawing party may also include receiving a first digital certificate having a signature of the first authority and/or a second authority, the certificate certifying that an identity of the withdrawing party can be caused to be revealed. Transferring a quantity of tokens from a depositing key of a depositing party to a withdrawing key of a withdrawing party may also include receiving a second digital certificate having a signature of the first authority, the second authority, and/or a third authority, the second digital certificate certifying that an identity of the depositing party can be caused to be revealed. The at least one first authority may correspond to a plurality of authorities, each having a portion of a secret key corresponding to the public key, or may be a single authority. The at least one first authority may reveal the identity of the withdrawing party in response to an appropriate request therefor. Transferring a quantity of tokens from a depositing key of a depositing party to a withdrawing key of a withdrawing party may also include receiving a cyphertext that includes an encrypted combination of a public key of the withdrawing party with a random value, the encrypted combination being encrypted with a public key of the at least one first authority, and receiving a zero-knowledge proof that the cyphertext includes the public key of the withdrawing party.

According further to the system described herein, tracing a transaction that transfers a quantity of tokens from a depositing key of a depositing party to a withdrawing key of a withdrawing party includes decrypting identifying information encrypted in a public key of at least one first authority, where the identifying information identifies the withdrawing key and causing the identifying information to be revealed. The at least one first authority may correspond to a plurality of authorities, each having a portion of a secret key corresponding to the public key, or may be a single authority. Tracing a transaction that transfers a quantity of tokens from a depositing key of a depositing party to a withdrawing key of a withdrawing party may also include using a certificate, issued by the first authority and/or a second authority, the certificate certifying that the withdrawing party and/or the withdrawing key can be caused to be revealed.

According further to the system described herein, a regulated mixer includes a receiver that receives a deposit of at least a quantity of tokens by a depositing key for withdrawal by a withdrawing key and a withdrawal authorization for the quantity of tokens and a proof that the withdrawing key is authorized to receive the quantity of tokens, the proof not revealing the depositing key. The regulated mixer also includes a mixer cryptographic component, coupled to the receiver, that verifies the proof that the withdrawing key is authorized to receive the quantity of tokens, and a transmitter, coupled to the mixer cryptographic component, that causes a transfer of the quantity of tokens to the withdrawing key in response to confirming validity of the proof. The receiver may receive a digital certificate having a signature of at least one trusted authority that verifies an identity of the withdrawing party and the transmitter may issue the quantity of tokens only after verifying the digital certificate and the signature of the at least one trusted authority. The withdrawal authorization may include an encrypted value and a zero-knowledge proof that a decryption of the encrypted value proves that a depositing party has deposited at least the quantity of tokens for withdrawal by the withdrawing party.

### BRIEF DESCRIPTION OF DRAWINGS

Embodiments of the system described herein will now be explained in more detail in accordance with the figures of the drawings, which are briefly described as follows.

The sole FIGURE illustrates a regulated mixer according to an embodiment of the system described herein.

### DETAILED DESCRIPTION OF VARIOUS EMBODIMENTS

In the description herein, public keys, authorities, and smart contracts may be personalized for convenience and brevity. In some cases, to disambiguate which is the subject of an action, or the possessor of something, the text use the following gender choices: “he”/“his” for a public key, “she”/“her” for an authority, and “it”/“its” for a smart contract.

### Clarifications.

Transferring Tokens. Transferring tokens to the smart contract SC includes transferring the tokens to an account from which the smart contract can cause tokens to be transferred.
Making Information Available. Information (e.g., a public key or a digital certificate) may be made available to the smart contract SC in many ways. For instance, by causing the information to be known to SC; posting the information in a database accessible to SC (e.g., the blockchain itself); and by taking no action, if the information is already available to SC. A party X may be deemed to make information available to SC acting alone or in collaboration with other parties. For instance, if X makes available to SC some part of the information and another party the balance of the information, then X has made the information available to SC. A first party may make some information available to a second party via an interactive process monitored by the second party or in which the second party participates.
Posting. Posting some information includes directly posting the information or causing the information to be posted (e.g., via one or more other parties) on the blockchain, and posting the information at a prior point in time.
Verifying. Verifying an item includes directly verifying the item; causing someone else to verify the item and receiving the result of such indirect verification; and having already verified the item.
Learning. Learning information includes learning the information from scratch, learning the information by putting together information, at least some of which already available, and knowing the information already.
Proofs. A proof of statement S includes a string proving S, an interactive proof of S via an interactive process (e.g., via an interactive proof), or no information if it is already clear that S is true.
Smart Contract. The smart contract of a mixer may be a single smart contract or may consist of a plurality of smart contracts. In the latter case, different actions can be taken by different smart contracts.

Note: If the first number of tokens (deposited) is greater than the second number of tokens (withdrawn), then SC can use the difference in any number of ways, including distributing the difference to one or more parties. (e.g., as fees, though the owner(s) of D and W can also pay some fees separately.) Further, SC may take additional actions to ensure that no one can withdraw more than the second number of tokens relative to the same deposit.

Embodiment 1 The depositors, the withdrawers, and the smart contract SC take the actions of a mixer in which a depositor D transfers a first number of tokens to SC so as to enable a withdrawer W of his choice to withdraw a second number of tokens without linking W to D. However, the following actions are also performed:

A proper authority issues a proper certificate C for W, C=SIG_{PK}_{_{A}}(W, ai).

In a withdrawal, a withdrawer W, in addition to his other withdrawal actions, makes C available to the smart contract SC.

In response to W's actions, SC, in addition to its other verifications,
learns PK_{A} and that PK_{A} belongs to a proper authority, and
verifies that C is a proper certificate.

If these and his other verifications are passed, then SC causes a transfer of the second number of tokens to W.

Note that Embodiment 1 is a certificate-based mixer.

CLARIFICATIONS. A proper certificate C=SIG_{PK}_{_{A}}(W, ai) may vouch that W has passed a proper Know-Your-Customer (KYC) process, that the identity of W's owner may be become known to proper authorities under proper circumstances (e.g., a court order), and that W is authorized to make a withdrawal.

Verifying that C is a proper certificate may include verifying that C is currently valid, that is, that C's duration period includes the current time. Verifying the validity of a certificate C may also include that C has not been revoked. Many techniques exist for certificate revocation. Making C available to SC may also include making available to SC a proof of the current validity of C.

An authority A may be a single authority or a collection of n authorities. In the latter case, no single authority in a collection may know the secret key of PK_{A}. Rather, each of the authorities may know a piece of (i.e., information about) such secret key, and a proper subset of the authorities (e.g., any majority of the authorities) are capable of producing a signature SIG_{PK}_{_{A}}(W, ai) and thus issue C.

Embodiment 2 Embodiment 2 is an authority-traceable mixer. To better explain Embodiment 2, it is useful illustrating first a simplistic attempt.

A SIMPLISTIC ATTEMPT. Consider modifying Embodiment 1 as follows. In a withdrawal, W also posts E_{PK}_{_{A}}(ti), that is, an encryption, relative to a public key PK_{A} of a proper authority A, of some traceability information that links W's withdrawal to the right depositor D. This simplistic approach, however, is insecure.

A SECURITY PROBLEM. A malicious W, rather than posting E_{PK}_{_{A}}(ti), may post E_{PK}_{_{A}}(ti′), that is, the encryption under key PK_{A} of a message totally different from ti. In fact, the smart contract, or any third party for this matter, has no way to tell that ti≠ti′. Thus, (1) W will be able to withdraw tokens, but (2) authority A will learn ti′ and thus will have no way of linking D's deposit to W.

THE SECURE EMBODIMENT. The depositors, the withdrawers, and the smart contract SC take the actions of a mixer in which a depositor D transfers a first number of tokens to SC so as to enable a withdrawer W of his choice to withdraw a second number of tokens without linking W to D. In addition, the following actions may take place.

In a withdrawal, the actions of a proper withdrawer W include causing making available to SC
1. an encryption E_{PK}_{_{A}}(ti), where (a) PK_{A} is a public key known by SC to belong to a proper authority and (b) ti is traceability information correctly linking W to D; and
2. a proof (e.g., a zero-knowledge proof) that the decryption of E_{PK}_{_{A}}(ti) correctly links W's withdrawal to D that does not reveal ti, nor D.

In response to W's actions, SC, in addition to any other verifications, verifies that the proof about the decryption of E_{PK}_{_{A}}(ti) is correct, and, if all verifications are passed, then SC causes a transfer of the second number of tokens to W.

CLARIFICATIONS. Information (1) and (2) may be caused to be provided to SC, not by W alone, but by D alone in in connection with the deposit of tokens by D, or by both D and W, or by others.

The secret decryption key of PK_{A} may be known solely to a single authority A. Alternatively, PK_{A} may be a public encryption key whose corresponding decryption key is not known to a single authority. Rather, there may be n authorities and each one of the authorities owns a secret “piece of” (i.e., some secret information about) PK_{A}'s decryption key, and any proper subset of the authorities (e.g., all of the authorities, any two of the authorities if n>2, etc.) may be able to decrypt information encrypted under PK_{A}, while other subsets of pieces (e.g., all subsets consisting of single piece alone) are unable to decrypt the secret key.

Embodiment 2 can be made also certificate-based by employing the techniques of Embodiment 1. For instance, the withdrawers and/or the depositors of Embodiment 2 may be required to have proper certificates issued by proper authorities, in order to make their deposits and/or their withdrawals.

Note that the depositor D may transfer the first number of tokens to SC at a given time without any knowledge of the withdrawer W at a given time of the deposit. That is, the depositor D may transfer tokens to SC prior to having chosen or identified a particular withdrawer W.

Thus, the information for the withdrawer W to make a withdrawal may be provided at a time that is later than the given time of the deposit.

Embodiment 3. Embodiment 3 is an authority-traceable mixer that can be considered more straightforward than Embodiment 2. To better explain Embodiment 3, consider the following simplistic attempt. Namely, Embodiment 2 is modified as follows. During a deposit, D also posts a deterministic encryption EA (W) of a withdrawer W that D has chosen. Adding the deterministic encryption has two positive consequences: (a) A immediately learns W and (b) only W can withdraw a second number of tokens. However, adding the deterministic encryption also suffers from a fundamental problem: in a withdrawal, the withdrawer W will become known, thus, everyone, not just a proper authority A, will be able to trace D's deposit to W. In fact, everyone can deterministically encrypt W with public key PK_{A} and check that the resulting ciphertext indeed coincides with E_{PK}_{_{A}}(W).

The following corrects the above problem of the simplistic version of Embodiment 3. In a deposit, a depositor D
transfers a first number of tokens to SC,
chooses a withdrawer W to withdraw a second number of tokens, and makes available to SC a ciphertext CT=E_{PK}_{_{A}}(W, r) (that is, a probabilistic encryption of W under a public key PK_{A} known by the smart contract to belong to a proper authority) wherein CT is securely coupled to D or D's deposit (that is, authority A is guaranteed that CT is associated to D or to D's deposit).

One example of securely coupling D to CT is a digital signature SIG_{D}(CT) or SIG_{D}(D, CT).

One example of securely coupling D's deposit to CT is SIG_{C}(DEP, CT), where DEP is the deposit. For instance if T is the first number of tokens, DEP=SIG_{D}(D, SC, T, ai), where ai is some additional information. A second example of securely coupling CT with D's deposit, is to specify CT or CT's hash within the deposit itself. For instance, D's deposit may be SIG_{D}(D, SC, T, H(CT), ai).

Either way the traceability of the withdrawing key W to the depositing key D is guaranteed, because whether A is a single authority knowing the entire secret decryption key of PK_{A} or a multiplicity of authorities collectively capable of decrypting CT, (1) it is guaranteed that CT corresponds to D and (2) information identifying W (in fact, in the above examples W itself) is available to authority A.

In a withdrawal, W makes available to SC a proof that his own key W is the decryption of the ciphertext CT made available in one of the previous deposits, where the proof does not reveal which of the previous deposits corresponds to the ciphertext CT (e.g., it is a zero-knowledge proof).

In response, SC verifies W's proof. If the proof is correct, then SC causes a transfer of the second number of tokens to W.

Note that, since the cyphertext includes information about the withdrawer W, the withdrawer W is known at a given time of a deposit. Thus, the information for the withdrawer W to make a withdrawal may be provided/generated at the same time or close to the same time as the given time of the deposit.

Referring to the sole FIGURE, a regulated mixer 30 includes a receiver 32, a mixer cryptographic component 34, and a transmitter 36. The regulated mixer 30 provides the functionality described herein. The receiver 32 receives data that is used by the mixer cryptographic component 34 to create a withdrawal authorization that does not identify a depositing party, as described elsewhere herein. The regulated mixer 30 may be implemented using a server or a plurality of interconnected servers located at the same facility, located in different facilities, or some combination thereof. In some embodiments, components of the regulated mixer 30 (e.g., the receiver 32, the mixer cryptographic component 34, and the transmitter 36) may be placed within a secure perimeter that protects the components and communications between the components from malicious actors that may try to obtain data from the regulated mixer 30 in an unauthorized manner. The secure perimeter maintains privacy for the regulated mixer 30. The secure perimeter may be a physical perimeter, a logical/cryptographic perimeter (e.g., data encryption), or a combination of both.

The receiver 32 may receive data that is used by the regulated mixer 30 to create withdrawal authorizations for withdrawing parties, as described elsewhere herein. The receiver 32 may receive, for example, a deposit request and/or one or more digital certificates having a signature of at least one trusted authority that verifies an identity of a withdrawing party and possibly also a depositing party. Data received by the receiver 32 may be provided by a depositing party and/or another entity (possibly on behalf of the depositing party). For example, the depositing party or another entity may provide an indication that at least a quantity of tokens is being deposited for withdrawal by a withdrawing party. Similarly, the depositing part or another entity may provide a digital certificate having a signature of at least one trusted authority that verifies an identity of a withdrawing party. The transmitter 36 may issue (or cause to have issued) the tokens for the withdrawing party.

The mixer cryptographic component 34 includes one or more processors 42 coupled to a non-transitory computer readable medium 44 containing software that, when executed by the processor 42, provides the functionality described herein. In some embodiments, the mixer cryptographic component 34 may include a secret key 46 that may be used by the processor 42 to provide a digital signature that verifies an identity of the withdrawing party (and possibly a depositing party), so that, in some cases, the regulated mixer 30 acts as a trusted authority to verify an identity of a withdrawing party and possible also verifies an identity of a depositing party.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, system configurations may vary from the illustrations presented herein. Further, various aspects of the system described herein may be deployed on any appropriate processing device using one or more use operating system(s) suitable for providing the functionality described herein, including, without limitation, an operating system selected from the group consisting of: IOS, Android OS, Windows, Blackberry OS and Linux OS. Certain components of the system may be cloud based.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The software may be bundled (pre-loaded), installed from an app store or downloaded from a location of a network operator. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of transferring a quantity of tokens from a depositing key of a depositing party to a withdrawing key of a withdrawing party, comprising:
receiving a deposit of at least the quantity of tokens for withdrawal by the withdrawing key and a withdrawal authorization for the quantity of tokens that does not identify the depositing key or the withdrawing key;
receiving a proof that the withdrawing key is authorized to receive the quantity of tokens, the proof not revealing the depositing key or the withdrawing key;
receiving a first digital certificate having a signature at least one authority that certifies that an identity of the withdrawing party can be caused to be revealed;
verifying the validity of the first digital certificate based on the signature of the at least one authority;
verifying that the withdrawing key is authorized to withdraw the quantity of tokens; and
causing a transfer of the quantity of tokens to the withdrawing key in response to confirming validity of the first digital certificate and confirming that the withdrawing key is authorized to receive the quantity of tokens.

2. The method of claim 1, wherein the withdrawing party provides at least one of: the first digital certificate and/or the proof.

3. The method of claim 1, wherein the at least one authority corresponds to a plurality of authorities, each having a portion of a secret key used to issue/digitally sign the first digital certificate.

4. The method of claim 1, wherein the at least one authority is a single authority.

5. The method of claim 1, wherein the at least one authority reveals the identity of the withdrawing party in response to an appropriate request therefor.

6. The method of claim 1, further comprising:
receiving a second digital certificate that certifies that an identity of the depositing party can caused to be revealed.

7. The method of claim 6, wherein the second digital certificate is issued by a same authority that issues the first digital certificate.

8. The method of claim 6, wherein the at least one authority reveals the identity of the depositing party in response to an appropriate request therefor.

9. A method of transferring a quantity of tokens from a depositing key of a depositing party to a withdrawing key of a withdrawing party, comprising:
receiving at a given time a deposit of at least the quantity of tokens for withdrawal by the withdrawing key;
receiving identifying information that identifies the withdrawing key, the identifying information being encrypted using a public key of a first authority to provide an encrypted value that is securely coupled to at least one of: the depositing key or the deposit or the depositing party;
receiving a proof that a decryption of the encrypted value identifies the withdrawing key, the proof not revealing the depositing key or the deposit to which the encrypted value is securely coupled;
verifying the proof; and
causing a transfer of the quantity of tokens to the withdrawing key in response to confirming validity of the proof.

10. The method of claim 9, wherein the withdrawing key is unknown at the given time of deposit.

11. The method of claim 9, wherein the proof is a zero-knowledge proof.

12. The method of claim 9, further comprising:
receiving a first digital certificate having a signature of at least one of: the first authority or a second authority, the certificate certifying that an identity of the withdrawing party can be caused to be revealed.

13. The method of claim 12, further comprising:
receiving a second digital certificate having a signature of at least one of: the first authority, the second authority, or a third authority, the second digital certificate certifying that an identity of the depositing party can be caused to be revealed.

14. The method of claim 9, wherein the at least one first authority corresponds to a plurality of authorities, each having a portion of a secret key corresponding to the public key.

15. The method of claim 9, wherein the at least one first authority is a single authority.

16. The method of claim 9, wherein the at least one first authority reveals the identity of the withdrawing party in response to an appropriate request therefor.

17. The method of claim 9, further comprising:
receiving a cyphertext that includes an encrypted combination of a public key of the withdrawing party with a random value, the encrypted combination being encrypted with a public key of the at least one first authority; and
receiving a zero-knowledge proof that the cyphertext includes the public key of the withdrawing party.

18. A method of tracing a transaction that transfers a quantity of tokens from a depositing key of a depositing party to a withdrawing key of a withdrawing party, comprising:
decrypting identifying information encrypted in a public key of at least one first authority, wherein the identifying information identifies the withdrawing key; and
causing the identifying information to be revealed.

19. The method of claim 18, wherein the at least one first authority corresponds to a plurality of authorities, each having a portion of a secret key corresponding to the public key.

20. The method of claim 18, wherein the at least one first authority is a single authority.

21. The method of claim 18, further comprising:
using a certificate, issued by a least one of: the first authority or a second authority, the certificate certifying that at least one of: the withdrawing party or the withdrawing key can be caused to be revealed.

22. A regulated mixer, comprising:
a receiver that receives a deposit of at least a quantity of tokens by a depositing key for withdrawal by a withdrawing key and a withdrawal authorization for the quantity of tokens and a proof that the withdrawing key is authorized to receive the quantity of tokens, the proof not revealing the depositing key;
a mixer cryptographic component, coupled to the receiver, that verifies the proof that the withdrawing key is authorized to receive the quantity of tokens; and
a transmitter, coupled to the mixer cryptographic component, that causes a transfer of the quantity of tokens to the withdrawing key in response to confirming validity of the proof.
